(19) United States
(12) Patent Application Publication
(10) Pub. No.: US 2024/0133484 A1
(43) Pub. Date: Apr. 25, 2024

(54) VACUUM VALVE WITH A WIRELESS ASSEMBLY

(71) Applicant: VAT HOLDING AG, Haag (CH)

(72) Inventors: Andreas HOFER, Chur (CH); Adrian ESCHENMOSER, Werdenberg (CH); Xunshuo ZHANG, Rüthi (CH); Frantisek BALON, Sevelen (CH)

(21) Appl. No.: 18/546,251

(22) PCT Filed: Feb. 16, 2022
(86) PCT No.: PCT/EP2022/053809

§ 371 Date: Aug. 10, 2023

(30) Foreign Application Priority Data
Feb. 17, 2021 (DE) 10 2021 000 787.5

(51) Int. Cl. F16K 37/00; F16K 51/02

(52) U.S. Cl. CPC F16K 37/0041; F16K 51/02

(57) ABSTRACT

Disclosed is a valve for regulating a volume or mass flow and/or for closing and opening a valve opening, having a valve seat, a valve closure and a drive unit which is coupled to the valve closure and is set up to provide a movement of the valve closure in such a way that the valve closure can be adjusted from an open position to a closed position and back. The vacuum valve includes a radio arrangement having at least one coupling element and a memory element, and information relating to a valve state can be provided by means of the memory element.

The invention relates to a vacuum valve having a radio arrangement, which radio arrangement is capable of providing or storing information about a current valve state.

In general, valves are designed to adjust the flow of a fluid in particular. With a valve, the flow can be allowed or completely shut off over a maximum valve opening cross-section. In addition, certain types of valves offer the possibility of regulating a flow rate per unit of time, i.e. they provide controllability of a fluid flow.

Vacuum valves constitute a specific type of valve. These are known in various embodiments from the prior art for the regulation of a volume or mass flow and/or for the essentially gas-tight closure of a flow path leading through an opening formed in a valve housing and are used in particular in vacuum chamber systems in the field of IC, semiconductor or substrate production, which must take place in a protected atmosphere as far as possible without the presence of contaminating particles.

Such vacuum chamber systems comprise in particular at least one evacuable vacuum chamber provided for accommodating semiconductor elements or substrates to be processed or manufactured, which vacuum chamber has at least one vacuum chamber opening through which the semiconductor elements or other substrates can be guided into and out of the vacuum chamber, and at least one vacuum pump for evacuating the vacuum chamber. For example, in a semiconductor wafer or liquid crystal substrate manufacturing system, the highly sensitive semiconductor or liquid crystal elements sequentially pass through a plurality of process vacuum chambers in which the parts located within the process vacuum chambers are processed by a respective processing device. Both during the processing procedure within the process vacuum chambers and during the transport from chamber to chamber, the highly sensitive semiconductor elements or substrates must always be in a protected atmosphere, in particular in an airless environment.

For this purpose, peripheral valves are used on the one hand to open and close a gas inlet or outlet, and on the other hand transfer valves are used to open and close the transfer openings of the vacuum chambers for feeding and discharging the parts.

The vacuum valves through which semiconductor parts pass are called vacuum transfer valves due to the described field of application and the associated dimensioning, also rectangular valves due to their mostly rectangular opening cross-section, and also slide valves, rectangular slide valves or transfer slide valves due to their usual mode of operation.

Peripheral valves are used in particular to control or regulate the flow of gas between a vacuum chamber and a vacuum pump or a further vacuum chamber. Peripheral valves are located, for example, within a pipe system between a process vacuum chamber or a transfer chamber and a vacuum pump, the atmosphere or a further process vacuum chamber. The opening cross-section of such valves, also called pump valves, is usually smaller than that of a vacuum transfer valve. Since, depending on the application, peripheral valves are used not only to fully open and close an opening, but also to control or regulate a flow by continuously adjusting the opening cross-section between a fully open position and a gas-tight closed position, they are also referred to as control valves. One possible peripheral valve for controlling or regulating the gas flow is the pendulum valve.

In a typical pendulum valve, as known for example from U.S. Pat. No. 6,089,537 (Olmsted), in a first step a generally round valve disk is rotationally pivoted over a generally also round opening from a position exposing the opening to an intermediate position covering the opening. In the case of a slide valve, as described for example in U.S. Pat. No. 6,416,037 (Geiser) or U.S. Pat. No. 6,056,266 (Blecha), the valve disk, like the opening, is usually rectangular in shape and is pushed linearly in this first step from a position exposing the opening into an intermediate position covering the opening. In this intermediate position, the valve disk of the pendulum or slide valve is in a spaced opposing position to the valve seat surrounding the opening. In a second step, the distance between the valve disk and the valve seat is reduced so that the valve disk and the valve seat are uniformly pressed against each other and the opening is closed in a substantially gas-tight manner. This second movement is preferably in a direction substantially perpendicular to the valve seat.

The sealing can be carried out, for example, either via a sealing ring arranged on the closing side of the valve disk, which is pressed onto the valve seat surrounding the opening, or via a sealing ring on the valve seat, against which the closing side of the valve disk is pressed. Due to the closing process taking place in two steps, the sealing ring between the valve disk and the valve seat is hardly subjected to shear forces which would destroy the sealing ring, since the movement of the valve disk in the second step takes place essentially in a straight line perpendicular to the valve seat.

Various sealing devices are known from the prior art, for example from U.S. Pat. No. 6,629,682 B2 (Duelli). A suitable material for sealing rings and seals in vacuum valves is, for example, fluororubber, also known as FKM, in particular the fluoroelastomer known under the trade name “Viton”, as well as perfluorubber, FFKM for short.

Various drive systems for achieving this combination of a rotational movement of the valve disk parallel across the opening in the case of a pendulum valve and a translational movement of the valve disk perpendicular to the opening in the case of a slide valve are known from the prior art, for example from U.S. Pat. No. 6,089,537 (Olmsted) for a pendulum valve and from U.S. Pat. No. 6,416,037 (Geiser) for a slide valve.

Particularly for vacuum applications, the valve disk must be pressed onto the valve seat in such a way that both the required gas tightness within the entire pressure range is ensured and damage to the sealing medium, in particular the sealing material or sealing ring (e.g. O-ring), due to excessive pressure stress, is avoided. In order to ensure this, known valves provide for a controlled contact pressure regulation of the valve disk depending on the pressure difference prevailing between the two valve disk sides. However, especially in the case of large pressure fluctuations or the change from negative pressure to positive pressure, or vice versa, an even distribution of force along the entire circumference of the sealing ring cannot always be guaranteed. In general, however, the aim is to decouple the sealing ring from support forces resulting from the pressure applied to the valve.

Since the above-mentioned valves are used, among other things, in the manufacture of highly sensitive semiconductor elements in a vacuum chamber, a corresponding sealing effect must also be reliably guaranteed for such vacuum chambers. For this purpose, the condition of the entire valve or, in particular, of a sealing material or of a sealing surface in contact with the sealing material during pressing is of particular importance. In the course of the operating life of a vacuum valve, changes of valve components can typically occur due to wear of the sealing material or the sealing surfaces as well as structural changes of the valve components, e.g. drive unit or valve stem, due to environmental influences (temperature, humidity, shocks, etc.).

In order to prevent any leakage that may occur in the process or to maintain the quality of the seal at a constantly sufficiently high level, a valve closure is typically replaced or renewed at certain intervals. Such a maintenance interval is usually measured by the number of opening and closing cycles to be expected in a certain period of time or by the number and severity of environmental influences. Maintenance is typically carried out as a precautionary measure in order to be able to exclude the occurrence of a leak as far as possible in advance.

Such a maintenance requirement is not limited to the sealing material or the valve disk, but extends in particular to other valve components such as the drive unit or the valve seat, which forms a part of the vacuum valve corresponding to the valve disk. The structure of a sealing surface on the part of the valve seat, for example a groove recessed in the valve seat, is also affected by a mechanical stress. Therefore, a structural change of the groove or the valve seat resulting from an operation of the valve may also cause an impairment of the seal. Appropriate maintenance intervals are usually defined for this as well.

The requirements described so far mainly using the example of vacuum valves can be transferred almost identically to valves in general.

However, one disadvantage of regular valve maintenance is that a loss of accuracy for the operation of the valve can occur due to the replacement of the valve disk, for example. On the one hand, such a replacement must ensure that the appropriate replacement part is installed, and on the other hand, this replacement part must then be precisely mounted on the valve in the manner intended. Both of these operations are strongly related to the skills of the person performing the maintenance and are therefore prone to error. The maintenance of a desired precision stands and falls with the ability of this person.

Furthermore, during maintenance it remains questionable how often or how long a part intended for maintenance has already been operated. This information is typically available from the valve operator, but not from the valve manufacturer or a maintenance company. It therefore regularly remains unclear whether there is an actual need for maintenance.

The invention is thus based on the object of providing an improved vacuum valve which reduces or avoids the above-mentioned disadvantages.

It is a further object of the invention to provide an improved vacuum valve, which provides or makes it possible to read out information relating to a maintenance requirement.

It is also a further object of the invention to provide an improved vacuum valve which provides a check with respect to operational integrity after a part change.

These objects are solved by the realization of the characterizing features of the independent claims. Features which further form the invention in an alternative or advantageous manner are to be taken from the dependent claims.

The basic idea of the present invention is to combine a vacuum valve with a radio arrangement, e.g. an RFID tag, having at least one memory and to enable reading or writing of the memory on the part of the vacuum valve (or by means of a valve controller). This may provide monitoring of an operational integrity and/or processing or storage of operational information for the valve.

By means of such an arrangement, a vacuum valve can, for example, be further developed into a “smart valve”, i.e. the vacuum valve can no longer only implement simple closing and opening commands, but can also provide additional functions and/or information.

The invention thus relates to a vacuum valve, more particularly a vacuum slide valve, pendulum valve or monovalve, for regulating a volume or mass flow and/or for closing and opening a valve opening. The vacuum valve comprises a valve seat which in turn comprises the valve opening defining an opening axis and a first sealing surface surrounding the valve opening.

The vacuum valve further has a valve closure, in particular a valve disk, for regulating the volume or mass flow and/or for closing the valve opening in a substantially gas-tight manner. The valve closure has a second sealing surface corresponding to the first sealing surface.

Furthermore, a drive unit coupled to the valve closure is provided, which is arranged and/or designed to provide a movement of the valve closure in such a way that the valve closure can be adjusted from an open position, in which the valve closure at least partially exposes the valve opening, into a closed position, in which there is sealing contact of the first sealing surface and the second sealing surface with a sealing material present therebetween and the valve opening is thereby closed in a gas-tight manner, and back.

The vacuum valve further comprises a radio arrangement including at least a coupling element and a memory element. By means of the memory element, information regarding a valve state can be provided.

In particular, the radio arrangement can be designed as an RFID transponder (RFID=radio-frequency identification) or as an NFC transponder (NFC=near field communication).

RFID generally relates to a technology for transmitter-receiver systems for, for example, automatic and contactless identification and localization of objects and living beings using radio waves.

An RFID system may, for example, comprise an RFID transponder (colloquially also called a radio tag), which may be located on or in an object or living being and may contain an identifying code, and a communication arrangement (e.g. reader) for reading this identifier.

RFID transponders can be manufactured comparatively small (e.g. the size of a grain of rice). Furthermore, an RFID transponder can be manufactured from polymers using a special printing process of stable circuits.

This makes it possible to provide a transponder with a small size at moderate manufacturing costs.

A coupling between the RFID transponder provided according to the invention and the communication arrangement, which comprises, for example, an antenna and/or a reader, can be established by means of short-range alternating magnetic fields generated by the communication arrangement or by means of high-frequency radio waves. Thus, not only data can be transmitted, but the transponder can furthermore be supplied with energy. Active RFID transponders can be used to achieve greater ranges. In this case, the RFID transponder can be connected to an energy source.

The communication arrangement may comprise a computer program (software or microprogram), wherein the computer program may be configured to control a read or write process. The communication arrangement may further comprise an interface (e.g. RFID middleware) for interfacing with other computer systems.

The RFID transponder may be specified with respect to its transmission frequency.

The RFID transponder comprises at least one antenna and one memory. In addition, an analog circuit for receiving and transmitting and a digital circuit may be provided. The digital circuit may be a microcontroller.

The memory element of the RFID transponder may be a memory that can be written to at least once. This can provide an unchangeable identity of the transponder, i.e. the data present on the memory is retained.

Alternatively or additionally, a rewritable memory can also be provided. This can be written with additional information, updated or deleted.

The RFID transponder can be designed as a passive, active or semi-active RFID transponder.

The passive RFID transponder can be supplied with energy by means of radio signals from the communication arrangement. For this purpose, a coil can be provided as a receiving antenna. This can be charged by induction and thus enables a response to be transmitted. Thereby, a reception of a response signal can be provided undisturbed by reflections of an interrogation signal from other objects. The range is typically limited due to the low power of the response signal.

The RFID transponder with its own energy supply can provide a greater range but also a greater range of functions (e.g. a temperature measurement).

The RFID transponder connected to a power source may be in a dormant state and, in particular, does not transmit any information unless it is activated (triggered) by a specific activation signal. This can significantly extend the life of the energy source.

The RFID transponder connected to the energy source can be designed as an active RFID transponder. In this case, the energy source can be used both for supplying a transponder-own microchip and for generating a modulated return signal. The range may in particular be kilometers.

The RFID transponder connected to the energy source can also be designed as a semi-active RFID transponder or semi-passive RFID transponder. This typically has no integrated transmitter, but only modulates a backscatter coefficient. For this, the range can be limited to approx. 100 m depending on the power and antenna gain of the transmitter.

The RFID transponder may be designed to communicate at a particular frequency. Long waves (e.g. 30-500 kHz), short waves (e.g. 3-30 MHz), very high frequencies (e.g. 433-950 MHz) or microwave frequencies (e.g. >2.4 GHz) may be used.

The coupling between the RFID transponder provided according to the invention and the communication arrangement may be realized by means of magnetic fields for an inductive coupling or near field coupling (NFC).

Alternatively, the coupling may be realized by means of electromagnetic dipole fields for far-field coupling.

In one embodiment of the invention, the radio arrangement, for example an RFID or NFC transponder, may be arranged on the valve closure (valve disk) or integrated into the valve closure.

Thus, the radio arrangement can be attached to a movable and comparatively maintenance-intensive component of the vacuum valve. The radio arrangement can thus provide information to be associated with the valve closure. This may include, for example, a part or serial number of the valve closure or the provision of a closure position. Further examples of information relating to the valve closure or a valve state are described below.

In one embodiment, the valve closure, the valve seat and/or the drive unit may comprise a transmission window configured to provide, in particular bidirectional, wireless communication of the radio arrangement through the transmission window.

For example, the valve closure may be made predominantly of aluminum or another metal. This choice of material may (strongly) impair, limit or make impossible a propagation or transmission of the radio waves required for communication. In particular in the case where the radio arrangement is to be integrated into the valve closure (i.e. at least partially enclosed by the valve closure), it may therefore be advantageous to form an area in the vicinity of or around the radio arrangement with an improved transmission property. For this purpose, this transmission window may in particular be non-metallic, e.g. polymer-based.

In particular, the radio arrangement can be cast into a recess provided for this purpose on the valve closure. The recess and/or the casting material used can then form the transmission window.

In one embodiment, the valve may comprise a communication arrangement configured to establish a coupling with the coupling element of the radio arrangement. The communication arrangement can be arranged and configured in such a way that wireless communication between the communication arrangement and the coupling element can be provided at least in the open position and/or the closed position. The communication arrangement comprises in particular at least one antenna.

In particular, the communication arrangement may be arranged on the valve seat, on the drive unit or on a valve housing, or may be integrated into the valve seat, the drive unit or the valve housing.

Accordingly, the valve may comprise a component (communication arrangement) cooperating with the radio arrangement. This communication arrangement may, for example, be attached to a non-movable part of the valve and be positioned in such a way that a radio link can be established with the radio arrangement and data or information can be transmitted via this link. The transmission may be bidirectional, i.e. data and/or information may be transmitted to the radio arrangement or received from the radio arrangement.

The positioning and design of the communication arrangement can be chosen in such a way that communication is only possible in a certain valve position, e.g. the open position, due to the range.

In one embodiment of the invention, the vacuum valve may comprise a read/write arrangement or an interface for communication with a read/write arrangement. The read/write arrangement may be configured to provide communication between the read/write arrangement and the memory element. The read/write arrangement can, for example, be part of the communication arrangement and be programmed and configured in such a way that it can be used to write data (information relating to the valve state) and/or read data to or from the storage element of an RFID tag.

Alternatively, the read/write arrangement may be implemented separately from the valve, for example as a portable reader, and establish a communication link with the memory element via the interface of the valve. The read/write arrangement may be embodied, for example, by a tablet PC, smartphone or other portable data-processing device and provided with appropriate software (e.g. app).

The communication between the radio arrangement and the communication arrangement or the read/write arrangement may comprise at least one of reading the information relating to the valve state from the memory element and/or storing the information relating to the valve state in the memory element.

In one embodiment of the invention, the information relating to the valve state may comprise at least one of the following:
a condition and/or state of the valve closure,
a condition and/or state of the sealing material,
an operating time of the valve,
a period of use of the valve closure,
a number of closing and/or opening cycles performed,
identification information, in particular a valve closure type or a part and/or serial number of the valve closure,
production information, in particular a production date and/or a production location, and/or
a calibration parameter.

By providing, updating or reading this information regarding the valve state, for example, a valve state can be logged or monitored. Furthermore, an operation of the valve can be adjusted or controlled depending on this information.

In one embodiment, the vacuum valve may comprise a control and processing unit comprising a control functionality and a monitoring functionality. The control functionality may be arranged to control the movement of the valve closure and the monitoring functionality may be configured such that, when executed, the information relating to the valve state is acquired and compared with a setpoint and an output is generated dependent on the comparison.

For example, the output may be provided acoustically, visually, or as a signal. For example, the output may be made available to a user, thereby providing the user of the vacuum valve with a decision aid for operation. Such a decision may be made, for example, as to whether to operate (or continue to operate) the valve in a current state. The output can be in the form of a warning signal, for example.

In this regard, the monitoring functionality may comprise at least one of monitoring, continuously monitoring, checking, verifying and/or comparing the information relating to the valve state.

In particular, depending on the output, the control functionality may be adapted, in particular the control of the movement of the valve closure may be adapted or the movement of the valve closure may be adapted, restricted or suspended. Such adjustment of the control functionality may in particular be automated. For this purpose, for example, a corresponding algorithm may be provided by which the monitoring functionality is controllable and/or executable and the control functionality is adaptable and/or executable. The monitoring functionality may in particular be arranged for optionally adapting the control functionality.

The setpoint may, for example, comprise or embody a permissible part identification information, in particular part number of the valve closure. The setpoint can also indicate a maximum permissible number of operating cycles or a maximum permissible age of the closure or its seal.

The adaptation of the control functionality can in particular comprise a switching off or activation of the drive unit. Here, for example, control or actuation of the drive unit can be prevented until the drive unit is enabled again by further execution of the monitoring functionality, i.e. the drive unit can, for example, be put out of operation and held until a specific enable signal is generated. Such a release can be effected, for example, by a specific setpoint being fulfilled within the scope of the monitoring or checking.

In one embodiment, information regarding an opening or closing state of the vacuum valve may be provided in response to the output. For example, the monitoring function can be used to determine whether the valve closure has reached a particular position or when the valve closure will reach a particular position during a planned movement.

Position information required for this purpose can, for example, be generated directly with the radio arrangement. Alternatively, the position information can be generated by means of a further sensor unit, e.g. encoder or limit switch, and further processed and/or transmitted using the radio arrangement.

According to one embodiment, information relating to maintenance with respect to at least one valve component can be provided depending on the output. For example, a current service life of a valve component can be logged by means of and/or on the radio arrangement and thus continuously monitored. This enables a (continuous) check as to whether a valve component concerned, for example the valve disk, has reached or will soon reach its intended service life (actuation cycles). It can further be estimated when the maximum operating time for the part will be reached. With this information available, maintenance of the valve can be planned or implemented. For example, a time for replacement of the valve disk can be determined (in advance) and a corresponding procurement of a replacement part can be initiated or also planned.

In particular, the monitoring functionality may be arranged to optionally provide the information as a function of the output.

In one embodiment of the invention, the control and processing unit may have memory functionality configured such that, when executed, information relating to the valve state is stored or updated on the memory element. This enables the radio arrangement to become a carrier of current valve information, e.g. the number of current closing operations carried out with the mounted valve disk can be continuously updated on the radio arrangement. For this purpose, a counter-element cooperating with the radio arrangement can be arranged on the valve seat, e.g. provided in the communication arrangement, wherein a signal is generated by a cooperation of the radio arrangement with the counter-element with each sealing process and thus the number of closing processes is increased by one in each case.

In one embodiment, the valve may comprise a separation device for separating a process atmosphere region from an external atmosphere region. In particular, this relates to an embodiment of the valve as a vacuum valve.

The process atmosphere region is to be understood in particular as a region which may be defined by a process chamber. In this region, a process atmosphere, in particular a vacuum, can be produced for processing substrates. Components intended for this region must meet requirements, for example, concerning material resistance and increased demands. Accordingly, the external atmosphere region is to be understood in particular as a region in which normal atmospheric conditions are present, e.g. room air.

Here, the drive unit can be at least partially, in particular completely, assigned to the external atmosphere area and the valve closure can be assigned in particular to the process atmosphere area.

The separating device of the valve can, for example, be formed by a bellows. The bellows can, for example, be provided inside the valve housing or the drive unit.

A valve known in the prior art and described, for example, in U.S. Pat. No. 6,772,989 comprises a valve body with two ports, a valve seat arranged in a flow path connecting the two ports in the flow chamber, and an opening opposite the valve seat. A piston of a pneumatic cylinder system is arranged in a valve cover closing the opening, which piston drives a valve disk, which opens and closes the valve seat, via a valve stem. The valve cover is attached to the opening in a gas-tight manner by a bellows plate. The two ends of a bellows surrounding the valve stem are attached in a gas-tight manner to the inner peripheral surface of the bellows plate and to the valve disk. The valve disk has an annular retaining groove on the surface facing the valve seat, in which a sealing ring is arranged.

A valve housing is made, for example, of aluminum or stainless steel, or internally coated with aluminum or another suitable material, while the valve disk and bellows are usually made of steel. The bellows, which can be expanded and compressed along its longitudinal axis within the range of the adjustment travel of the disk, seals the flow chamber airtight from the valve stem and the actuator. Two main types of bellows are used. On the one hand, the diaphragm bellows, and on the other hand, the corrugated bellows, which is distinguished from the diaphragm bellows by the fact that it has no welded seams and is easier to clean, but has a smaller maximum travel.

The invention also relates to a valve closure, in particular a valve disk, in particular a vacuum valve disk, for a vacuum valve, wherein the valve closure is designed for regulating a volume or mass flow and/or for closing and opening a valve opening defined by a valve seat of the valve in a gas-tight manner by means of interaction with the valve opening. The valve closure has a second sealing surface which corresponds to a first sealing surface of the valve seat which surrounds the valve opening, and also has a sealing material which is arranged on the second sealing surface, in particular is vulcanized thereon.

The valve closure has a radio arrangement, in particular an RFID transponder, having at least one coupling element and a memory element, wherein the memory element provides information relating to a valve state and/or is designed such that such valve-specific information can be stored on the memory element.

An advantage of such an arrangement of a radio arrangement on or in a valve closure is the associated possibility of detecting a current valve state and, based on this detected valve state, of making a decision for the further operation of the valve, for example of carrying out an adjustment of the closing movement (speed, contact pressure, etc.) or of planning a replacement of the valve closure.

In one embodiment of the invention, the memory element of the radio arrangement may provide information relating to the valve closure as a valve state, in particular at least one of the following information:
a condition and/or state of the valve closure,
a condition and/or state of the sealing material,
identification information, in particular a valve closure type or a part and/or serial number of the valve closure,
a production information, in particular production date and/or production location,
a calibration parameter, and/or
a software update.

The invention also relates to a method for controlling a valve described above. The method comprises at least the following steps of
reading out the information relating to the valve state from the memory element of the radio arrangement,
comparing the information regarding the valve state with a target state for the valve,
generating output based on the comparison,
processing the output, and
defining or updating a movement profile for the valve closure.

The invention further relates to a computer program product comprising program code stored on a machine-readable medium, in particular a control and processing unit of a valve described above, or computer data signal embodied by an electromagnetic wave for carrying out or controlling the steps of the above method.

The valve according to the invention is described in more detail below by way of example by reference to exemplary embodiments shown schematically in the drawings. Identical elements are marked with the same reference signs in the figures. The described embodiments are generally not shown to scale and they are also not to be understood as a limitation.

The figures show in detail:

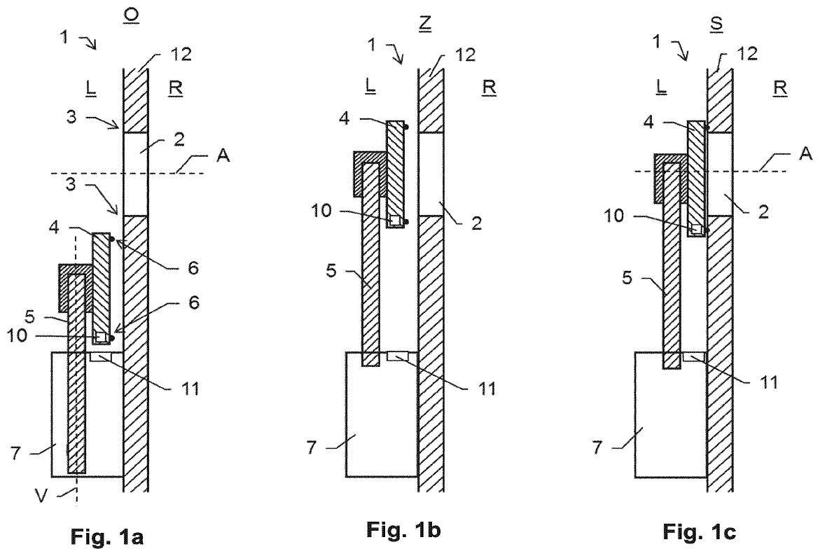

FIGS. 1a-c show a first embodiment of a valve according to the invention with RFID transponder;

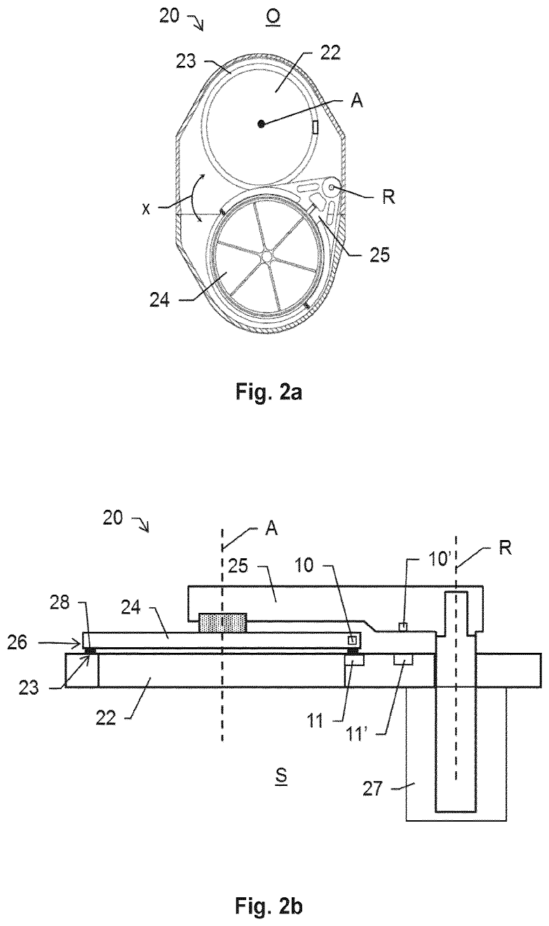

FIGS. 2a-b show a further embodiment of a valve according to the invention as a pendulum valve;

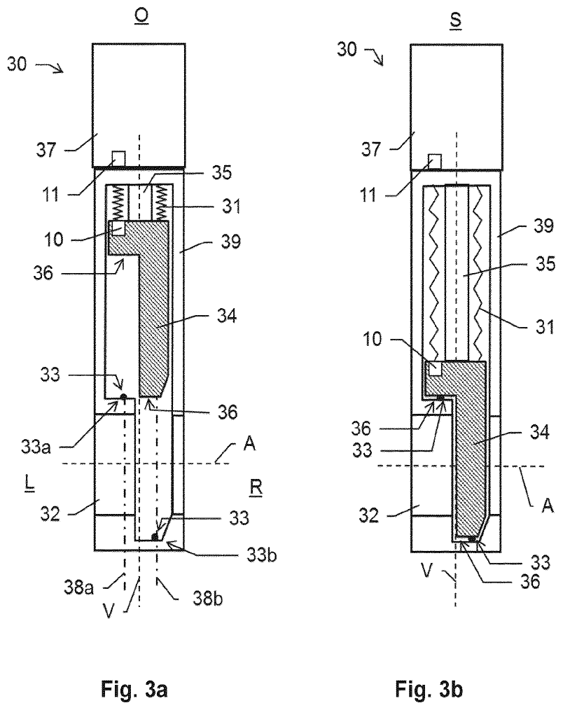

FIGS. 3a-b show a further embodiment of a valve according to the invention as a monovalve;

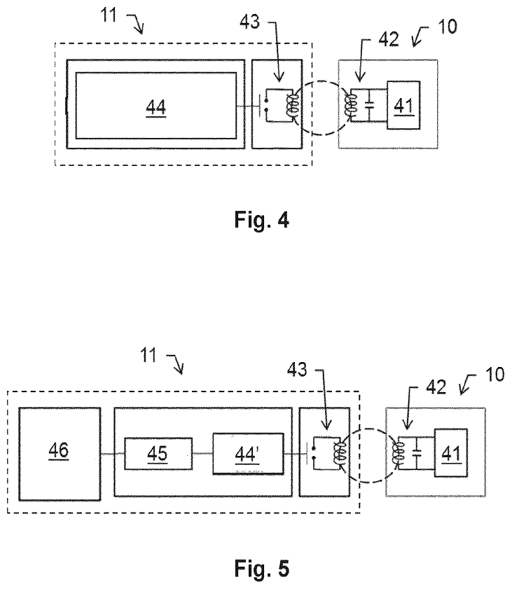

FIG. 4 shows an embodiment of an RFID arrangement of a valve according to the invention; and

FIG. 5 shows another embodiment of an RFID arrangement of a valve according to the invention.

FIGS. 1a-1c show an embodiment of a valve 1 according to the invention, which is designed as a vacuum transfer valve 1, shown in different closing positions.

The vacuum valve 1 has a rectangular, plate-shaped valve closure 4 (valve disk), which has a sealing surface 6 (second sealing surface) for the gas-tight closure of an opening 2. The opening 2 has a cross-section corresponding to the valve closure 4 and is formed in a wall 12. The wall 12 may, for example, be the wall of a vacuum process chamber. The opening 2 is surrounded by a valve seat, which in turn also provides a sealing surface 3 (first sealing surface) corresponding to the sealing surface 6 of the valve closure 4. The sealing surface 6 of the valve closure 4 surrounds the valve closure 4 and comprises a sealing material (seal). In a closed position S (FIG. 1c), the seal is compressed between the sealing surfaces 6 and 3.

The opening 2 connects a first gas region L, which is located to the left of the wall 12, to a second gas region R to the right of the wall 12. The wall 12 is formed, for example, by a chamber wall of a vacuum chamber. The vacuum valve 1 is then formed by an interaction of the chamber wall 12 with the valve closure 4.

It will be understood that the valve seat together with the first sealing surface 3 may alternatively be formed as a valve component structurally fixed to the valve 1 and may for example be arranged, for example screwed, to a chamber opening.

The valve closure 4 may, as shown here, be arranged on an adjustment arm 5, which is here for example rod-shaped, and extends along a geometrical adjustment axis V. The adjustment arm 5 is mechanically coupled to a drive unit 7, by means of which the closure member 4 can be adjusted in the first gas region L to the left of the wall 12 by adjusting the adjustment arm 5 by means of the drive unit 7 between an open position O (FIG. 1a) via an intermediate position Z (FIG. 1b) into a closed position S (FIG. 1c).

In the open position O, the valve closure 4 is outside a projection area of the opening 2, fully exposing it, as shown in FIG. 1a.

By linearly moving the valve closure 4 in an axial direction in a plane parallel to or coaxial with the adjustment axis V and parallel to the wall 12, the valve closure 4 can be moved from the open position O to the intermediate position Z by means of the drive unit 7.

In this intermediate position Z (FIG. 1b), the sealing surface 6 of the valve closure 4 is at a distance opposite the sealing surface 3 of the valve seat surrounding the opening 2.

By adjusting in the direction of the opening axis A defined by the opening 2 (here: transverse to the adjustment axis V), i.e. e.g. perpendicular to the wall 12 and the valve seat, the valve closure 4 can be adjusted from the intermediate position Z to the closed position S (FIG. 1c).

In the closed position S, the valve disk 4 closes the opening 2 in a gas-tight manner and separates the first gas region L from the second gas region R in a gas-tight manner.

The vacuum valve is opened and closed by means of the drive unit 7, in this case by an L-shaped movement in two directions H and A of the valve closure 4, which are perpendicular to each other, for example. The valve shown is therefore also called an L-type valve.

A transfer valve 1 as shown is typically provided for sealing a process volume (vacuum chamber) and for loading and unloading the volume. Frequent changes between the open position O and the closed position S are the rule in such an application. This can lead to increased wear of the sealing surfaces 6 and 3, the interposed seal and the mechanically moved components.

The vacuum valve 1 further comprises a radio arrangement 10 comprising a coupling element, for example an antenna, and a memory element. The radio arrangement 10 is arranged on the valve closure 4. On the memory element, for example, information may be stored which allows identification of an embodiment (type) of the valve closure 4 and/or allow a position to be determined.

In particular, the radio arrangement 10 may be in the form of an RFID transponder (RFID tag).

Furthermore, the valve 1 has a communication arrangement cooperating with the radio arrangement 10 here in the form of an antenna 11. The antenna 11 is here arranged on the drive unit 7. The antenna 11 is also coupled to a read/write unit. The read/write unit may also be arranged on the side of the valve 1 or may alternatively be designed separately therefrom, in particular as part of a control unit. In particular, the antenna 11 may form a single unit with the read/write unit. The coupling of the antenna 11 with the read/write unit can be implemented, for example, by cable or inductively.

The radio arrangement 10 and the antenna 11 are arranged and designed in such a way that, at least in the open position O, information transmission or communication between the radio arrangement 10 and the antenna 11 can be carried out. In the open position O, there is a constructionally minimal distance between the radio arrangement 10 and the antenna 11, whereby communication is best possible in this position.

In particular, the radio arrangement 10 and the antenna 11 (or the downstream read/write unit) can be designed in such a way that, due to the transmission and reception ranges of these components, this is only possible in the open position O. In this embodiment, it is advantageous that interactions with the communication radiation used for this purpose can be avoided.

In one embodiment, the read/write unit can be triggered to attempt to establish a connection with the transponder 10 only when the open position O is reached or close to the open position O. A corresponding signal to activate the read/write unit can be triggered, for example, by the drive unit 7, for example by triggering a limit switch when the open position O is reached.

The communication between the radio arrangement 10 and the read/write unit can, for example, confirm that the open position O has been reached. In addition, by reading a type identification, it can be verified whether a valve closure suitable for the valve 1 is mounted. In a case where, for example, it cannot be confirmed that the valve disk 4 has reached the correct open position or that the appropriate disk 4 is mounted, an appropriate signal can be generated and output. Based on the signal, a user can be warned or the control system (control and processing unit) can be caused to adjust its functionality. In particular, in the event of a corresponding warning signal, the control unit can prevent further operation of the drive unit in order to avoid potential damage to the valve 1 in the event of further operation.

In one embodiment, the memory of the radio arrangement 10 can contain calibration data determined in the course of a preliminary calibration of the valve closure 4 on a similar valve 1 for precisely this valve closure 4, i.e. data relating, for example, to a specific target positioning and/or relating to a specific contact pressure for providing a desired seal. This data can be read out, for example after a replacement of the valve disk 4, and can be adopted and/or further processed by a control and processing unit controlling the drive 7 of the valve 1. For example, the closing movement can thus be individually adapted and thus optimized for the valve closure 4 installed in each case.

Alternatively or additionally, information may be stored on the radio arrangement 10 by the read/write unit. For example, continuously at each operating cycle, a current number of closing operations already performed with the mounted valve disk 4 can be updated on the memory. Thus, in case of a planned maintenance of the valve disk 4, an actual operating time for the disk 4 can be read out and the maintenance work can be adapted to the operating time. For example, depending on this, a decision can be made as to whether a complete replacement of the disk 4 is required or whether a replacement of the seal (at the sealing surface 6) appears to be sufficient.

In another variant, the RFID tag 10 of the valve disk 4 may include programming data embodying programming of a valve-side control and processing unit. In other words, the tag 10 may provide firmware or an update of firmware configured to operate the valve. This provided programming may be read via the antenna 11 and further processed such that the programming is stored (installed) as current control and provided and/or executed for operation of the valve on the valve-side control and processing unit.

FIG. 2a and FIG. 2b schematically show a further possible embodiment of the vacuum valve according to the invention in the form of a pendulum valve 20. The valve 20 is designed in particular for regulating a mass flow and comprises a valve housing which has an opening 22. The opening 22 has here, for example, a circular cross-section. The opening 22 is enclosed by a valve seat. This valve seat is formed by a (first) sealing surface 23 which faces axially in the direction of a valve disk 24 (valve closure), extends transversely with respect to the opening axis A and has the shape of a circular ring, and is formed in the valve housing. The valve disk 24 is pivotable about a rotation axis R and adjustable substantially parallel to the opening axis A. In a closed position S (FIG. 2b) of the valve disk 24 (valve closure), the opening 22 is closed in a gas-tight manner by means of the valve disk 24, which has a second sealing surface 26 with sealing material. An open position of the valve disk 24 is illustrated in FIG. 2a.

The valve disk 24 is connected to a drive unit 27 via an adjustment element 25 (arm) arranged laterally on the disk and extending perpendicularly to the opening axis A. This arm 25 is located in the closed position of the valve disk 24 outside the opening cross-section of the opening 22 geometrically projected along the opening axis A.

The drive 27 is designed by using a motor and a corresponding gear in such a way that the valve disk 24—as is usual in a pendulum valve—can be pivoted between an open position and an intermediate position by means of a transverse movement x of the drive 27 transversely to the opening axis A and essentially parallel across the cross-section of the opening 22 and perpendicular to the opening axis A in the form of a pivoting movement about the pivot axis R and can be displaced linearly by means of a longitudinal movement of the drive 27 parallel to the opening axis A. In the open position, the valve disk 24 is positioned in a dwell section arranged laterally adjacent to the opening 222 so that the opening 22 and the flow path are unobstructed. In the intermediate position, the valve disk 24 is positioned spaced above the opening 22 and covers the opening cross-section of the opening 22. In the closed position S, the opening 22 is closed in a gas-tight manner and the flow path is interrupted by a gas-tight contact between the sealing surface 26 of the valve closure 24 (valve disk) and the sealing surface 23 of the valve seat by means of a sealing material.

To enable automated and regulated opening and closing of the valve 20, the valve 20 provides, for example, an electronic regulation and control unit (control and processing unit) (not shown), which is designed and connected to the drive 27 in such a way that the valve disk 24 can be adjusted accordingly to close off a process volume or to regulate an internal pressure of this volume.

In the present exemplary embodiment, the drive 27 is designed as an electric motor, wherein the transmission is switchable in such a way that driving the drive 27 causes either the transverse movement x or the longitudinal movement. The drive together with the gear is controlled electronically by the control system. Such gears, in particular with gate-type gear shift, are known from the prior art. Furthermore, it is possible to use several drives to effect the rotational movement and the linear movement, wherein the control unit takes over the control of the drives.

Precise regulation or adjustment of the flow with the described pendulum valve 20 is possible not only by pivoting adjustment of the valve disk 24 between the open position O and the intermediate position by means of the transverse movement, but above all by linear adjustment of the valve disk 24 along the opening axis A or P between the intermediate position and the closed position S by means of the longitudinal movement. The described pendulum valve can be used for precise regulation tasks.

Both the valve disk 24 and the valve seat each have a sealing surface—a first and a second sealing surface 23 and 26. The second sealing surface 26 of the valve disk 24 also has the seal 28. This seal 28 may, for example, be vulcanized onto the valve disk 24 as a polymer by means of vulcanization. Alternatively, the seal 28 may be in the form of an O-ring in a groove of the valve seat, for example. Also, a sealing material may be bonded to the valve disk 24 or the valve seat, thereby embodying the seal 28. In an alternative embodiment, the seal 28 may be arranged on the side of the valve seat, in particular on the first sealing surface 23. Combinations of these embodiments are also conceivable. Such seals 28 are of course not limited to the valve 20 described in the example, but are also applicable to the further valve embodiments described.

For example, the valve disk 24 is variably adjusted based on control variables and an output control signal. For example, information about a current pressure condition in a process volume connected to the valve 20 is received as an input signal. In addition, a further input variable, for example a mass inflow into the volume, may be provided to the controller. Based on these variables and based on a predetermined target pressure to be set or achieved for the volume, a controlled adjustment of the valve 20 is then performed over the time of a control cycle, so that a mass outflow from the volume can be controlled over time by means of the valve 20. For this purpose, a vacuum pump may be provided downstream of the valve 20, i.e. the valve 20 is arranged between the process chamber and the pump. Thus, a desired pressure curve can be adjusted.

By adjusting the valve closure 24, a respective opening cross-section for the valve opening 22 is set and thus the possible gas quantity which can be evacuated from the process volume per unit of time is set. For this purpose, the valve closure 24 can have a shape deviating from a circular shape, in particular in order to achieve the most laminar media flow possible.

The valve 20 also includes two RFID transponders 10 and 10′ forming a respective radio arrangement. A first of the RFID transponders 10 is arranged on the valve disk 24 in the region of the second sealing surface 26. A second of the RFID transponders 10′ is arranged on the adjustment arm 25. In the embodiment shown, the RFID transponders 10 and 10′ are integrated into the respective components.

Accordingly, the valve 20 comprises two communication arrangements 11 and 11′. A first of the communication arrangements 11 is arranged on the valve seat in the region of the first sealing surface 23. A second of the communication arrangements 11′ is arranged on the valve housing. In the embodiment shown, the communication arrangements 11 and 11′ are integrated into the respective components. The communication arrangements 11 and 11′ each comprise an antenna, a read/write unit and optionally an integrated power source or a connection to a power supply.

The RFID transponder 10 and the communication arrangement 11 are designed and arranged to enable corresponding communication in the intermediate position and/or in the closed position S. In contrast, an exchange of information is not possible in the open position O. The components are thus coordinated with each other with a small range. With this combination of RFID transponder 10 and communication arrangement 11, it is possible, for example, to determine whether the valve disk 24 is in the closed position S and to generate a corresponding feedback.

The RFID transponder 10′ and the communication arrangement 11′ are constructed and arranged in such a way that a counterposition of these components is only present in the open position O and a corresponding communication is only possible in the open position O. The communication arrangement 11′ is arranged in such a way that it is covered by the arm 25 in FIG. 2a. This combination also makes it possible to determine when a certain position (open position O) has been reached. In addition, closing and opening cycles of the valve 20 are counted and a corresponding number is continuously stored directly on the RFID transponder 10′ (RFID tag).

With such an arrangement, for example, a respective reaching of an end position with respect to a pivoting of the valve disk 24 about the axis of rotation P can be determined. A signal that can be generated accordingly can then be further processed in connection with the control of the drive 27 and thus, for example, a continuous calibration of the drive 27 can take place.

The transponder 10 may alternatively or additionally contain identification information. Here, for example, a disk type or a part and/or serial number of the valve disk 24 may be stored. The same also applies to the transponder 10′ with respect to information about the adjustment arm 25.

In particular, the transponder 10 may further provide information about a condition and/or a state of the valve closure 24 and/or the sealing material 28 present. Here, for example, geometric information describing a size of the valve disk 24, such as a thickness of the disk 24, may be stored and a sealing material used may be designated. After this information has been read out, the control of the valve 20 can be adapted on the basis of this information in such a way that a desired contact pressure is generated when the valve 20 closes.

Alternatively or additionally, at least one of the RFID transponders 10 and 10′ can provide manufacturing information, in particular a production date and/or a production location. In this way, in the event of a malfunction, it can be determined quickly, reliably and efficiently where and under what conditions the component in question was manufactured. Troubleshooting in the production process is thus significantly simplified.

FIGS. 3a and 3b schematically show a further embodiment of a vacuum valve 30 according to the invention. In the example, the valve 30 is designed as a so-called monovalve and shown in cross-section in an open position O (FIG. 3a) and a closed position S (FIG. 3b).

The valve 30 for closing a flow path in a gas-tight manner by means of a linear movement comprises a valve housing 39 with an opening 32 for the flow path, wherein the opening 32 has a geometric opening axis A along the flow path. The opening 32 connects a first gas region L, which in the drawing is located to the left of the valve 30 or a partition (not shown), to a second gas region R to the right thereof. Such a partition wall is formed, for example, by a chamber wall of a vacuum chamber.

The closure element 34 (valve disk) is linearly displaceable along a geometrical adjustment axis V extending transversely to the opening axis H in a closure element plane from an open position O uncovering the opening 32 into a closed position S linearly pushed over the opening 32 in a closing direction and vice versa back into an opening direction by means of a drive unit 37 with a movable adjusting element 35, in the example an adjustment arm.

For example, a (curved) first sealing surface 33 surrounds the opening 32 of the valve housing 39 along a first section 33a in a first plane 38a and along a second section 33b in a second plane 38b. The first plane 38a and the second plane 38b are spaced apart, extend parallel to each other and parallel to the closure element plane. Thus, the first section 33a and the opposing second section 33b have a geometric offset with respect to each other transversely to the adjustment axis V and in the direction of the opening axis A. The opening 32 is arranged between the two opposing sections 33a and 33b in the region extending along the adjustment axis V.

The closure element 34 comprises a second sealing surface 36 corresponding to the first sealing surface 33 and extends along sections corresponding to the first and second sections 33a, 33b.

In the example shown, a seal-forming material is provided on the first sealing surface 33 of the valve seat. Alternatively or additionally, the seal may be disposed on the second sealing surface 36 of the valve closure.

The seal may, for example, be vulcanized onto the valve seat as a polymer by means of vulcanization. Alternatively, the seal may be, for example, an O-ring in a groove of the valve seat. Also, a sealing material may be bonded to the valve seat and thereby embody the seal. Such seals are of course not limited to the valve 1 described in the example, but are also applicable to the further valve embodiments described.

Monovalves, i.e. vacuum valves that can be closed by means of a single linear movement, for example, have the advantage of a comparatively simple closing mechanism, e.g. compared with transfer valves that can be closed by means of two movements, which require a drive designed in a relatively complex manner. Moreover, since the closing element can be formed in one piece, it can be subjected to high acceleration forces, so that this valve can also be used for quick and emergency closures. Closing and sealing can be performed by means of a single linear movement, so that very fast closing and opening of the valve 30 is possible.

In particular, an advantage of monovalves is, for example, that the seal is not subject to any transverse load in the transverse direction to the longitudinal extension of the seal due to its course during closing. On the other hand, due to its transverse extension with respect to the opening axis A, the seal is hardly able to absorb forces occurring on the closure element 34 along the opening axis H, which can act on the closure element 34 in particular in the case of a large differential pressure, which requires a robust design of the closure element 34, its drive and its bearing.

The vacuum valve 30 further comprises a bellows 31. The bellows 31 is connected on the one hand to the valve closure 34 and on the other hand to the valve housing 39. This can provide atmospheric separation of the drive unit 37 and the adjustment arm 35 from a process volume. In the open valve state (FIG. 3a) the bellows is compressed, in the closed valve state 30 (FIG. 3b) the bellows is expanded.

In accordance with the invention, the vacuum valve 30 shown in FIGS. 3a and 3b comprises a radio arrangement 10 and a communication arrangement 11 cooperating with the radio arrangement 10. The two arrangements are capable of being moved closer and further away from each other along a direct axis by means of the drive unit 37.

This constellation may make a distance determination between the radio arrangement 10 and the communication arrangement 11 accessible. The distance determination may be performed, for example, by means of a measurement of the signal strength or by means of a superposition of the normal radio signal of the communication arrangement 11 with an additional localization signal.

In the latter case, the localization signal can be designed in such a way that it is repeated periodically. The signal is selected to be so weak that it remains undetected by the RFID transponder. As a result, a response of the tag to the actual radio signal remains unaffected, so the read-out data is transmitted as usual. Nevertheless, the RFID tag reflects back parts of the localization signal. By specifically adding up the time-recurring signals, the reflected response in the reader can be reliably distinguished from random noise, and thus the propagation time of the signal and thus also the distance can be calculated.

The distance determination, in turn, may provide the control and processing unit with positional information for the valve closure 34, and thus corresponding control feedback. In addition, the radio arrangement 10 may include identification information for the valve disk 34 and the communication arrangement 11 may be configured to read this information.

FIG. 4 shows a radio arrangement 10 and a communication arrangement 11 of a valve according to the invention.

The radio arrangement 10 is designed as an RFID transponder (RFID tag) and comprises a coupling element 42 and a memory element 41. The coupling element 42 may, for example, be designed in the form of an antenna. The communication arrangement 11 also has a coupling element, in this case in the form of an antenna 43, and a read/write arrangement 44. According to another embodiment not shown, the communication arrangement 11 may have only an antenna 43 or be designed as an antenna.

In particular, the RFID tag 10 also includes a microchip that provides data management for the memory element 41.

As shown, the coupling element 42 of the RFID tag 10 and the antenna 43 of the communication arrangement 11 are in a coupled communication state, i.e. the two components are coupled and information is exchanged. The coupling is realized by means of an (electro)magnetic field. In particular, the coupling can be established when the distance between the two coupling elements falls below a certain minimum distance. Such a minimum distance depends, for example, on a signal strength that can be generated and/or on a transmission frequency used.

FIG. 5 shows a further embodiment of a radio arrangement 10 and a communication arrangement 11 of a vacuum valve according to the invention. In contrast to the embodiment according to FIG. 4, the communication arrangement 11 here has, in addition to the antenna 43, a circuit 44′ designed for internal coupling with the antenna 43 and a reading chip 45. The circuit 44′ and the reading chip 45 thus form a reading unit for reading the tag 10. In addition, a microprocessor 46 is provided for controlling and data processing with the reading unit.

It is understood that these figures shown are only schematic of possible exemplary embodiments. The various approaches can also be combined with each other and with prior art devices and methods.

1. A vacuum valve for regulating a volume or mass flow and/or for closing and opening a valve opening, comprising
a valve seat having the valve opening defining an opening axis and a first sealing surface surrounding the valve opening,
a valve closure, in particular a valve disk, for regulating the volume or mass flow and/or for substantially gas-tight closure of the valve opening with a second sealing surface corresponding to the first sealing surface, and
a drive unit coupled to the valve closure and adapted to provide movement of the valve closure such that the valve closure is adjustable from
an open position, in which the valve closure at least partially releases the valve opening to
a closing position in which there is sealing contact of the first sealing surface and the second sealing surface with a sealing material present therebetween and the valve opening is thereby closed in a gas-tight manner,
and back again,
wherein
the vacuum valve comprises a radio arrangement having at least one coupling element and a memory element, and
information relating to a valve state can be provided by means of the memory element.

2. The vacuum valve according to claim 1, wherein the radio arrangement is designed as an RFID transponder or NFC transponder.

3. The vacuum valve according to claim 1, wherein the radio arrangement is arranged on the valve closure or is integrated in the valve closure.

4. The vacuum valve according to claim 1, wherein the valve closure, the valve seat, a valve housing and/or the drive unit has a transmission window which is designed to provide, in particular bidirectional, wireless communication of the radio arrangement through the transmission window.

5. The vacuum valve according to claim 1, wherein the vacuum valve has a communication arrangement designed to establish a coupling with the coupling element of the radio arrangement, which communication arrangement is arranged and designed in such a manner that at least in the open position and/or the closed position a wireless communication can be provided between the communication arrangement and the coupling element, in particular wherein the communication arrangement comprises at least one antenna.

6. The vacuum valve according to claim 1, wherein the communication arrangement is arranged on the valve seat, on the drive unit or on a valve housing, or is integrated into the valve seat, the drive unit or the valve housing.

7. The vacuum valve according to claim 1, wherein the vacuum valve has a read/write arrangement or an interface for communication with a read/write arrangement, wherein the read/write arrangement is configured such that communication can be provided between the read/write arrangement and the memory element.

8. The vacuum valve according to claim 4, wherein the communication comprises reading out the information regarding the valve state from the memory element and/or storing the information regarding the valve state in the memory element.

9. The vacuum valve according to claim 1, wherein the information relating to the valve state comprises at least one of the following:
a condition and/or a state of the valve closure,
a condition and/or a state of the sealing material,
a vacuum valve operating time,
a period of use of the valve closure,
a number of closing and/or opening cycles performed,
identification information, in particular a valve closure type or part and/or serial number of the valve closure,
production information, in particular the date and/or place of production,
a calibration parameter.

10. The vacuum valve according to claim 1, wherein the vacuum valve comprises a control and processing unit with a control functionality and a monitoring functionality, wherein
the control functionality is arranged to control the movement of the valve closure, and
the monitoring functionality is configured such that, when it is executed, the information relating to the valve state is acquired and compared with a setpoint and an output dependent on the comparison is generated.

11. The vacuum valve according to claim 10, wherein the monitoring functionality is configured such that depending on the output, the control functionality is adaptable, in particular the control of the movement of the valve closure is adaptable or the movement of the valve closure is adapted, restricted or suspended.

12. The vacuum valve according to claim 10, wherein the monitoring functionality is configured in such a way that, depending on the output, information relating to an opening or closing state of the vacuum valve can be provided.

13. The vacuum valve according to claim 10, wherein the monitoring functionality is configured such that, depending on the output, information relating to maintenance of at least one valve component can be provided.

14. The vacuum valve according to claim 10, wherein the control and processing unit comprises a memory functionality configured such that, when executed, the information relating to the valve state is stored or updated on the memory element.

15. A valve closure, for a vacuum valve, wherein the valve closure is designed to regulate a volume or mass flow and/or to close and open in a gas-tight manner a valve opening defined by a valve seat of the vacuum valve by means of interaction with the valve opening, and comprises
a second sealing surface corresponding to a first sealing surface of the valve seat surrounding the valve opening, and
a sealing material arranged on the second sealing surface, in particular vulcanized thereon,
wherein
the valve closure has a radio arrangement, in particular an RFID transponder, having at least one coupling element and a memory element, and the memory element provides information relating to a valve state.

16. The valve closure according to claim 15, wherein the memory element provides information relating to the valve closure as a valve state, in particular at least one of the following information:
a condition and/or a state of the valve closure,
a condition and/or a state of the sealing material,
identification information, in particular a valve closure type or a part and/or serial number of the valve closure,
production information, in particular the date and/or place of production,
a calibration parameter.

17. A method for controlling a vacuum valve according to claim 1, comprising
reading out the information relating to the valve state from the memory element of the radio arrangement,
comparing the information regarding the valve state with a target state for the vacuum valve,
generating output based on the comparison,
processing the output and
defining or updating a movement profile for the valve closure.

18. A computer program product having program code stored on a non-transitory machine-readable medium, comprising: code to perform the steps of the method according to claim 17.
